(19) United States
(12) Patent Application Publication
(10) Pub. No.: US 2004/0213129 A1
(43) Pub. Date: Oct. 28, 2004

(54) Emitter cluster for a data storage device

(76) Inventor: Daniel R. Marshall, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/424,008

(22) Filed: Apr. 25, 2003

(51) Int. Cl. G11B 9/10

(52) U.S. Cl. 369/101; 369/126

(57) ABSTRACT

Embodiments of emitter clusters for a data storage device are provided, each such emitter cluster including a plurality of electron sources. Each electron source is configured to emit an electron beam to form a collective spot on a storage medium.

### BACKGROUND

Various types of data storage devices are known, including optical storage devices, magnetic storage devices and electron storage devices. Each of these storage device types strives for an optimal balance between storage density and cost for its desired marketplace.

Electron storage devices, for example, may be used in situations where high storage density is desired. Such electron storage devices typically include electron emitters, or emitting sources, and electron optics adapted to generate and focus electron beams. These electron beams are used to produce an image or spot on the surface of a storage medium, and thus to read data from and/or write data on the storage medium. Electron beams, it will be appreciated, typically are able to read and/or write relatively small recorded spots, in comparison to the larger recorded spots produced by some optical and/or mechanical recording mechanisms. Such smaller recorded spots may facilitate a higher density of recorded information in an electron storage device.

In order to achieve a desired energy concentration, electron storage devices typically focus on the size of the electron emitter. The size of the electron emitter may effect the energy transfer efficiency from the electron emitter to the storage medium. Thus, many available small electron emitters have relatively low brightness, and are capable only of producing a relatively low energy concentration at the storage medium. Generation of recorded spots with low energy concentration, it will be appreciated, may adversely affect recording density, signal quality and/or energy efficiency of the storage device.

In some electron storage devices, the electron beam may be reduced to a focused spot on the media using demagnification lenses configured to produce a spot that is substantially smaller than the emitting source. Such demagnification may facilitate storage of more data on the device, and may concentrate the energy generated from the electron emitter so as to overcome deficiencies in the electron emitter itself. However, such lenses may be cost prohibitive, and may unnecessarily add to the size and/or complexity of the device. Existing electron storage devices also may experience aberrations in the focused spot, possibly caused by imperfections in the beam-focusing mechanism. These aberrations may result in low-quality image formation, with resulting larger focused spots and low energy concentration. Such aberrations also may result in non-uniform spots that, in turn, may affect signal-to-noise ratio, potentially leading to loss of data at the associated data storage location.

### SUMMARY

Embodiments of emitter clusters for a data storage device are provided, each such emitter cluster including a plurality of electron sources. Each electron source is configured to emit an electron beam to form a collective spot on a storage medium. BRIEF DESCRIPTION OF THE DRAWINGS

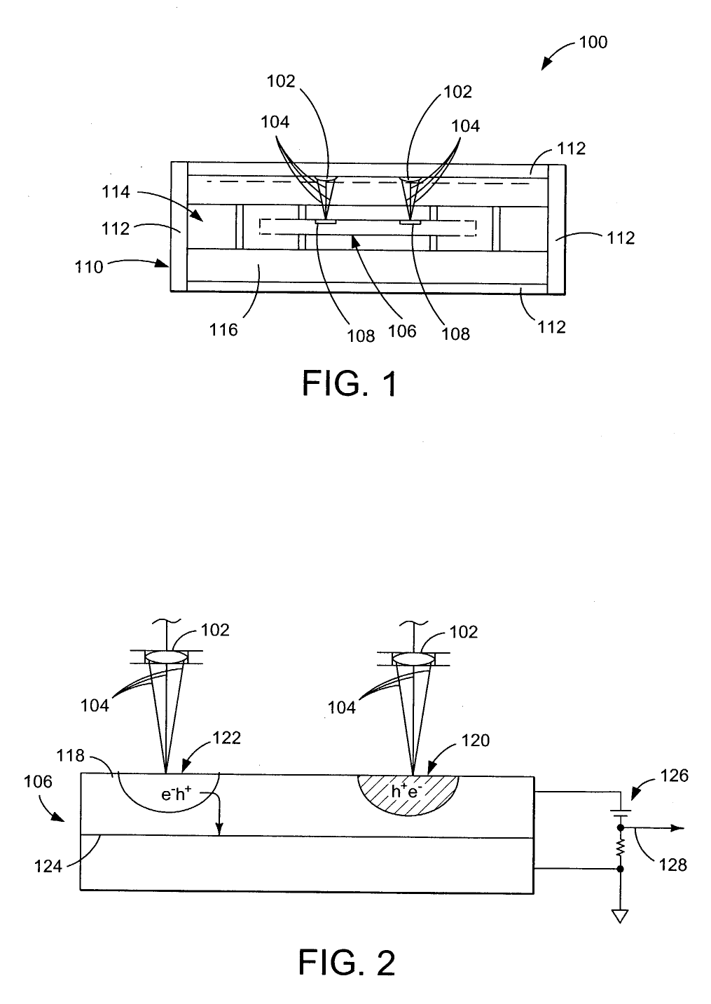

FIG. 1 is a somewhat schematic cross-sectional side view of an exemplary electron storage device including emitter clusters according to an embodiment of the present invention.

FIG. 2 is a schematic diagram illustrating operation of the exemplary electron storage device shown in FIG. 1.

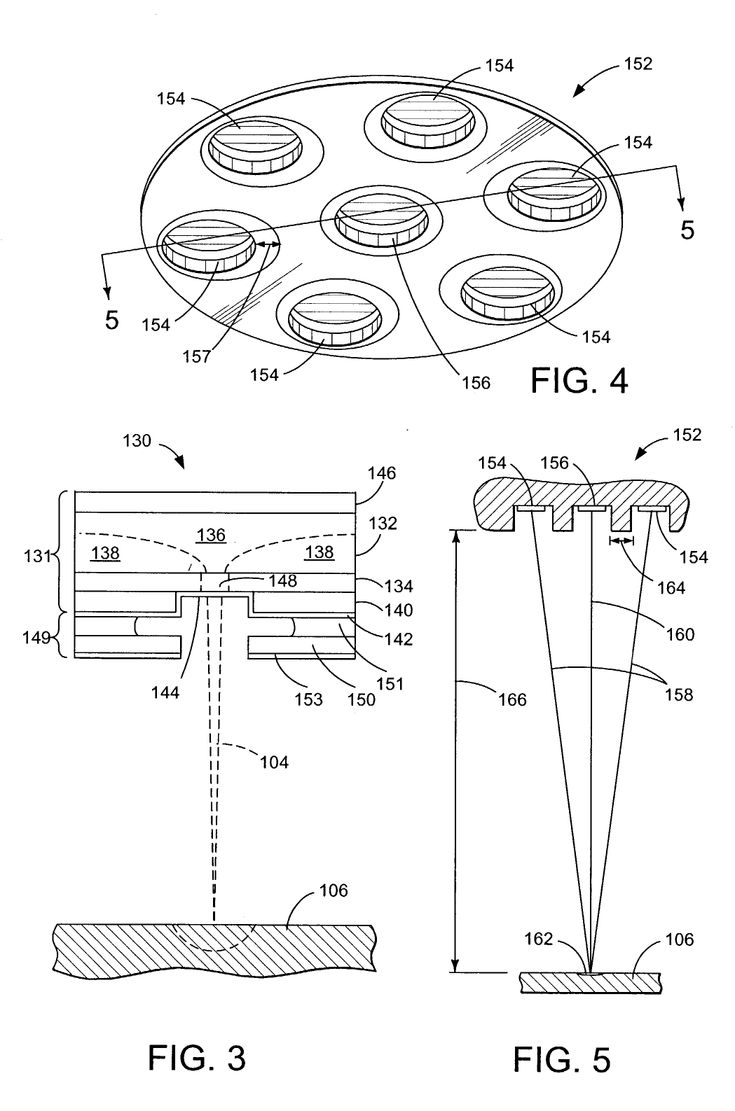

FIG. 3 is a schematic side view of an embodiment of a flat emitter suitable for use within the emitter cluster shown in FIG. 1.

FIG. 4 is a perspective view of an exemplary emitter cluster having a plurality of satellite electron emitters symmetrically offset from a central electron emitter according to an embodiment of the present invention.

FIG. 5 is a more schematic illustration of the emitter cluster shown in FIG. 4, such emitter cluster being shown to generate a plurality of electron beams focused on a single recording spot.

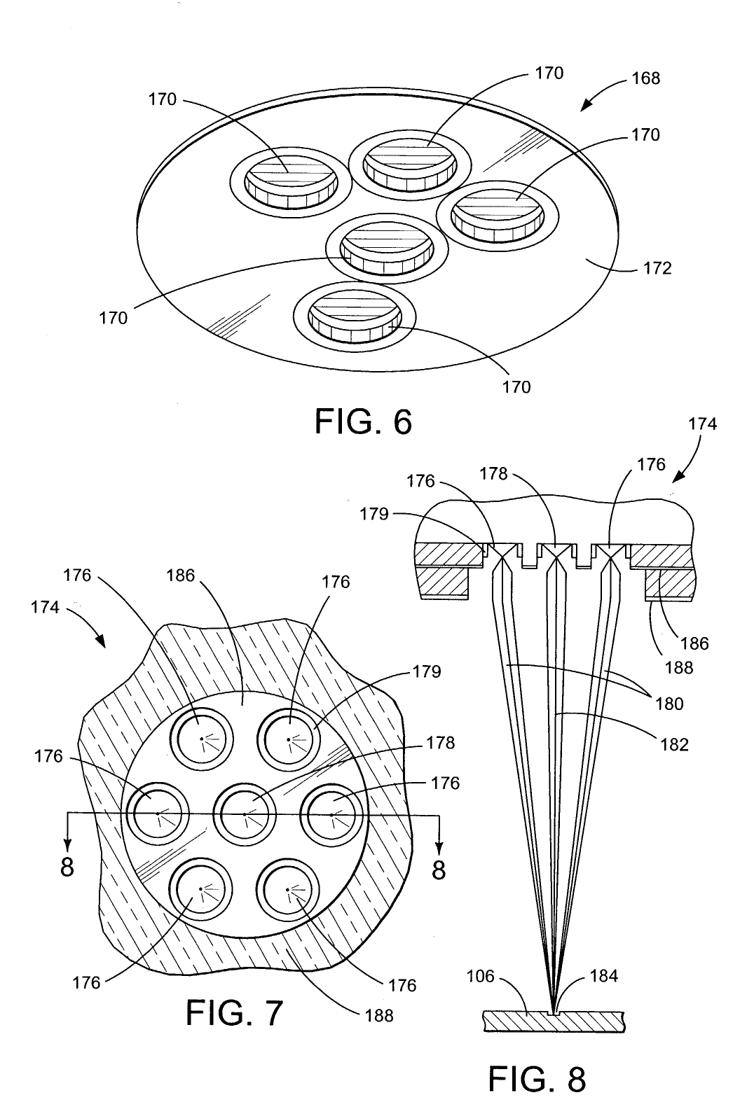

FIG. 6 is a perspective view of another emitter cluster arrangement according to an embodiment of the present invention.

FIG. 7 is a top view of another alternative emitter cluster having two types of focusing electrodes according to an embodiment of the present invention.

FIG. 8 is more schematic illustration of the emitter cluster shown in FIG. 7, such emitter cluster being shown to generate a plurality of electron beams focused on a single recording spot.

### DETAILED DESCRIPTION

Referring initially to FIG. 1, an electron storage device according to an embodiment of the present invention is shown generally at 100. Storage device 100 includes a number of emitter clusters 102 (described in more detail below), each configured to generate a plurality of electron beams 104. The electron beams may be focused onto a storage medium 106 having a number of data storage areas or storage locations 108.

A somewhat similar storage device is described and disclosed, for example, in U.S. Pat. No. 5,557,596 to Gibson et al., the disclosure of which is hereby incorporated by reference. It is within the context of such a storage device that the emitter clusters are described. It should be noted, however, that the emitter clusters described herein may be used in a variety of other types and/or configurations of electron storage devices where electron beams are used to read data from and/or write data to a storage medium.

A casing 110 is adapted to maintain storage medium 106 in partial vacuum. Specifically, casing 110 may include a plurality of walls 112 that define an interior space 114. Walls 112 are coupled together such that at least a partial vacuum may be maintained within interior space 114. It should be appreciated that different configurations for casing 110 also are contemplated.

Each emitter cluster 102 may be configured to match up with one or more data storage areas on storage medium 106. As indicated, a single emitter cluster includes a plurality of electron sources (also referred to herein as electron emitters). These electron emitters typically are configured to emit electron beam currents, also referred to herein, as electron beams. At any given moment, each cluster may produce plural electron beams directed toward a single data storage location 108 on storage medium 106. Each storage location 108, in turn, may be configured to store one or more bits of data.

Where emitter clusters are each responsible for a number of storage areas, storage device 100 typically is adapted to effect relative movement between the emitter clusters 102 and storage medium 106. A micromover 116, for example, is configured to scan or move storage medium 106 with respect to the emitter clusters, or vice versa. Micromover 116 thus may be adapted to scan medium 106 to different locations, so that emitter cluster 102 may be positioned above different data storage locations. With such a configuration, micromover 116 may be used to substantially align the storage medium relative to the emitter clusters. It also should be understood that relative movement may be obtained by displacing the emitter clusters, or by displacing both the emitter clusters and the storage medium.

In any event, it will be appreciated that emitter clusters 102 are configured to read from and/or write to data storage locations 108 via the electron beams which they produce. Thus, emitter clusters suitable for use with storage device 100 produce electron beams narrow enough to achieve the desired data bit density on storage medium 106. Further, the emitter clusters provide electron beams of sufficient energy concentration to perform the desired read/write operations. Although spaced from the storage medium, it will be understood that the emitter clusters are in sufficiently close proximity to data storage locations 108 that electron beams from the emitter clusters may be selectively directed onto the data storage locations without much loss of energy.

As described above, the electron beams produced via the emitter clusters may be used to read data from and/or write data to the storage medium. In some embodiments, writing is accomplished by temporarily increasing the energy concentration of the electron beams such that the electron beams modify the surface state of a data storage location. Similarly, reading is accomplished by observing the effect of the data storage location on the electron beams or the effect of the electron beams on the data storage location.

For example, a data storage location in a first state may represent a “1” bit, and a data storage location in a second state may represent a “0” bit, or vice versa. It is further possible to modify the data storage location to different degrees to represent more than two bits. The surface state may be permanent or reversible (temporary). The permanently modified storage medium may be suitable for write-once-read-many memory (WORM).

In some embodiments, storage medium 106 may be constructed of a material whose structural state can be selectively changed between an amorphous and crystalline state using the electron beams. Germanium telluride (GeTe) (and ternary alloys based on GeTe) is representative of such a material. To change from the amorphous to the crystalline state, the energy concentration of the beam is increased, and then slowly decreased. This increase/decrease heats the amorphous area and then slowly cools it so that the area has time to anneal into its crystalline state. To change from the crystalline to amorphous state, the energy concentration of the beam is increased to a high level, and then rapidly reduced.

FIG. 2 illustrates operation of the exemplary electron storage device shown in FIG. 1, the storage device being shown to include a storage medium 106 in the form of a diode structure 118. Diode structure 118, may take the form of a pn junction, a Schottky barrier, or any other suitable type of electronic valve, and may define plural data storage locations (represented herein by storage locations 120, 122), each configured to record or store data based on the storage location's energy state.

Accordingly, a bit of data may be stored by locally altering the surface of a diode in such a way that the collection efficiency for minority carriers generated near an altered region or written area (indicated, for example, at storage location 120) is different from that of an unaltered region or unwritten area (indicated, for example, at storage location 122). The collection efficiency for minority carriers may be defined as the fraction of minority carriers generated by the incident electrons that are swept across the diode junction 124 when it is biased by a biasing circuit 126.

For example, in the depicted embodiment, the storage medium is arranged as a diode having two layers. By way of example, one of the layers is p-type and the other is n-type. The storage medium may be connected to an external circuit that reverse-biases the storage medium. It should be noted that charge carriers (holes and electrons) are present in the storage medium. The more abundant charge carriers are called majority carriers; the less abundant are called minority carriers. In n-type semiconductor material, electrons are the majority carriers and holes are the minority carriers. In p-type semiconductor material, the electrons are the minority carriers and the holes are the majority carriers.

Upon application of an electron beam or beams, as shown, the aforementioned minority carriers cause a signal current 128 to flow in the external circuit. The magnitude of the current resulting from the minority carriers may depend on the energy state of the data storage location on which the electron beams are incident. It should be appreciated that other methods may be used to read and write data, including for example, collecting and measuring backscattered or secondary electrons.

As indicated in FIG. 2, each emitter cluster 102 are configured to emit a plurality of narrow electron beams 104 onto the surface of the storage medium. The incident electrons, in turn, excite electron-hole pairs (represented by e−h+ in FIG. 2) near the surface of the diode in the data storage location on which the electron beams are incident. As used herein, a hole is an electric charge carrier with a positive charge, equal in magnitude, but opposite in polarity, to the charge on an electron. The diode may be reverse-biased by a biasing circuit 126 so that the minority carriers that are generated by the incident electrons may be swept across diode junction 124. In other words, minority carriers that do not recombine with majority carriers before reaching the junction are swept across the junction, causing a current to flow in biasing circuit 126.

As discussed generally above, writing onto the storage medium may be accomplished by irradiating a data storage location with electron beams of sufficient energy concentration to locally alter some property or properties of the diode structure in that data storage location (referred to as “write” electron beams). The alteration affects the number of minority carriers swept across the junction 124 when the same area is irradiated with lower energy concentration “read” electron beams.

For example, the recombination rate in a written data storage location 120 may be increased relative to the recombination rate in an unwritten data storage location 122 so that the minority carriers generated in the written data storage location have an increased probability of recombining with majority carriers before they have a chance to reach and cross the junction 124. Hence, a smaller current flows in the biasing circuit 126 when the “read” electron beams are incident upon a written data storage location than when the “read” electron beams are incident upon an unwritten data storage location. It will be appreciated, however, that it is also possible to start with a diode structure with a high recombination rate, and to write data by locally reducing the recombination rate. The resulting current thus may constitute an output signal 128 indicative of the storage location's energy state.

Electron sources, such as electron emitters, may be arranged in functional groups, referred to herein as emitter clusters 102. The electron emitters may be any suitable type of electron source, including flat emitters and point emitters. For simplicity, an emitter cluster arrangement will initially be described in the context of a grouping of flat emitters.

FIG. 3 illustrates an exemplary flat emitter 130, however it should be appreciated that other configurations for flat emitter 130 are possible. FIG. 3 illustrates an exemplary flat emitter 130 having an electron emission structure, indicated generally at 131. Electron emission structure may include a substrate 132, formed of an n++ semiconductor such as silicon, and a semiconductor layer 134. Substrate 132 may be fabricated such that it includes a volcano-like, funnel-like, or nozzle-like active region 136. Active region 136 may be surrounded by an isolation region 138 that limits the area from which the active region can emit electrons. In addition to limiting the geometry of the active region, in some embodiments, the isolation region may isolate the active region from neighboring active regions. However, in other embodiments, it will be understood that the active regions of contiguous electron emitters may be connected together.

Flat emitter 130 may further include an emission electrode 140 formed on semiconductor layer 134 of substrate 132. Emission electrode 140 may be used to supply voltage to semiconductor layer 134. A conductive layer 142 typically covers emission electrode 140 and a portion of the outer surface of the semiconductor layer, including an emission surface 144. The conductive layer provides an electrical contact over the emission surface and enables an electric field to be applied across the emission surface.

In some embodiments, flat emitter 130 may further include a back contact 146 that is formed on the substrate on a side opposite that on which the semiconductor layer is formed. When provided, the back contact establishes an equipotential surface for internal fields in the semiconductor substrate.

During operation, different potentials may be applied (e.g., with on or off-chip drivers) to substrate 132, via emission electrode 140 and back contact 146. The resulting emission electrode voltage, in turn, cause electrons to be injected from active region 136 of substrate 132 into a region 148 of semiconductor layer 134. The electrons are emitted from emission surface 144, through conductive layer 142. The electron emission results in an electron beam 104 that may be directed such that it impinges a selected target data storage location on storage medium 106.

Depending on the distance between the electron emitters and the storage medium, the type of electron emitters (such as point or flat emitters), and the spot size desired, electron optics or other focusing structures 149 may be used to focus the electron beams onto the desired data storage location. For illustrative purposes only, focusing structure 149 includes a lens electrode (also referred to herein as a focusing electrode or focusing lens) 150, an insulating layer 151, and a conductive layer 153. Focusing electrode 150 may be formed so as to define an aperture through which electron beams can pass. For example, the focusing electrode may form a ring through which the electron beam passes.

In some embodiments, focusing electrode 150 are spaced some distance from emission surface 144 as shown by insulating layer 151. Thus, insulating layer 151 isolates the emission electrode 140 from focusing electrode 150. In other embodiments, the focusing electrode may be in close proximity to emission surface 144. Like conductive layer 142, conductive layer 153 provides a contact over the corresponding electrode such that an electric field can be applied thereto. Although only one focusing electrode is illustrated, it should be appreciated that any number of focusing electrodes may be employed to focus the electron beam.

In operation, a potential is applied to focusing electrode 150, generating an electric field. Because the electrons in the electron beam are negatively charged, application of an electric field to the electron beam, results in an electrostatic force. The beam reacts to the applied potential, moving in response to the resulting electric field. The resulting electric field may be used to focus the emitted electrons in the electron beam on to a selected location on the storage medium. Typically, this focus may be adjusted by varying the potential applied to the focusing electrode. A voltage may also be applied to storage medium 106 to either accelerate and/or decelerate the emitted electrons, or to aid in focusing the electron beam.

As described above, emitter cluster 102 typically includes a plurality of electron emitters configured to generate plural electron beams 104, all directed to a single data storage location. The electron beams 104 are positioned such that the images (also referred to herein as spots) generated by the plural electron beams coalesce to form a collective spot on the data storage location. Thus, the electron beams typically are configured to converge toward each other. In some embodiments, the electron beams may converge at a single point on the storage medium forming a collective spot wherein each of the electron beams overlap or are substantially superimposed. In other embodiments, the electron beams may not actually converge on the storage medium, but instead, may reach the surface of the storage medium in close proximity to one another. The concentration of the beams in close proximity operates to form the collective spot described above.

The use of a plurality of electron emitters to produce a collective spot may accommodate use of a plurality of relatively small electron emitters to achieve a substantially similar concentration of energy and smaller spot size to that achieved using a larger electron emitter. Smaller electron emitters may more efficiently control emission and focusing than larger electron emitters. Additionally, the thermal properties of smaller electron emitters may be better than those of a single larger electron emitter. This, in turn, may enable higher local energy concentration where smaller electron emitters are employed. Moreover, it may be easier to manufacture smaller emitters, which may be able to utilize inherent crystallographic features within the storage medium.

FIGS. 4 and 5 depict one possible configuration for an emitter cluster. Specifically, the illustrated emitter cluster, indicated generally at 152 in FIG. 4, includes a plurality of electron emitters 154 and 156. As described above, the emitters may be any suitable type of electron emitter, including point emitters or flat emitters. In the configuration illustrated, electron emitters 154, referred to herein as satellite electron emitters, surround central electron emitter 156, forming a ring around the central electron emitter. It should be noted that although only one central electron emitter and six satellite electron emitters are illustrated, any number of central electron emitters and satellite electron emitters may be employed.

As shown in FIGS. 4 and 5, satellite electron emitters 154 are symmetrically offset from central electron emitter 156 such that the electron beams 158 and 160 are substantially superimposed on the storage medium to form a collective spot 162. Each satellite electron emitter may further be offset with respect to the focusing electrode (as indicated at 157) such that the electron beam is directed toward the other electron beams produced by the emitter cluster. It should be appreciated that the satellite electron emitters do not need to be symmetric within the cluster, and such asymmetric electron emitters may be focused using one or more focusing electrodes to form a collective spot.

Regardless of the arrangement of the electron emitters within the emitter cluster, each of electron beams 158 and 160, generated via electron emitters 154 and 156, may be separately focused and/or aligned using any suitable focusing structure such that the beams are coincident to form a collective spot 162 on storage medium 106. It should be appreciated that the beams need not be coherent, either within a single electron emitter, or with respect to each other, though coherent emission is not excluded. The emitter cluster and electron optics thus may be understood to work together to ensure that the electron beams, and the resultant spots, are substantially superimposed. Superimposition of the spots from the plurality of electron beams results in a collective spot having a relatively uniform distribution of energy.

As described above, in some embodiments, one or more of the electron emitters may be directed or positioned using electron optics, such as focusing electrodes. Different types and arrangements of such electron optics may be used depending on the configuration of the emitter cluster. For example, individual electron emitters may have their own separate focusing electrodes. Additionally, or alternatively, in some embodiments, a single focusing electrode may function to direct multiple electron beams. The relative position of the electron beams on the storage medium may be adjusted by varying the potential applied to the various focusing electrodes.

Typically, only one voltage driver is used for each emitter cluster. The voltage drivers typically power the focusing electrodes such that they produce electric fields. However, in some embodiments, multiple voltage drivers may be used. For example, each electron emitter or group of electron emitters within a cluster may be separately driven with a separate voltage driver.

The arrangement of the electron emitters within the emitter cluster may moderate off-axis aberrations or deviations from the collective spot. For example, minimizing the spacing between the electron emitters, as shown generally at 164, and/or the spacing from the electron emitters to the storage medium, as shown generally at 166, may function to minimize off-axis aberrations and to ensure a highly-energized, but small, collective spot. Non-circular shapes of the emission surfaces of the electron emitters may also be used to decrease the effect of off-axis aberrations. Similarly, the effect of a single misaligned electron emitter may be decreased as a result of having multiple aligned electron emitters producing a cumulative collective spot with a relatively higher energy concentration. In other words, the energy concentration in a collective spot formed via an emitter cluster is not significantly reduced by the misalignment of a single electron emitter within the emitter cluster.

Typically, electron emitters 154 and 156 in an emitter cluster may be operated simultaneously for best spot power and uniformity. However, it should be noted that if one or more of the electron emitters fail, the remaining operating electron emitters within the emitter cluster may continue to provide enough energy for reading and writing. Thus, although failure of an electron emitter may result in proportionately reduced energy, the redundancy of multiple electron emitters enables the emitter cluster to continue to function. Such redundancy within the emitter cluster may increase the reliability of the associated storage device.

Additionally, failure of a single electron emitter may not propagate to neighboring emitter clusters due to the physical arrangement of the electron emitters within the emitter clusters. Instead, a point failure within the emitter cluster may be limited in its effect on other electron emitters within the emitter cluster. The emitter cluster may operate to isolate any such failure and prevent the failure from spreading to electron emitters in neighboring emitter clusters.

The alignment of the electron emitters and the focusing electrodes may be done in )the photolithographic process that defines successive layers of the electron emitter. Therefore, in some embodiments, only one alignment step may be required for all of the electron emitters in an emitter cluster. Typically, it is is possible to align the electron emitters within an emitter cluster as a group. Thus, reducing the multiple alignment steps previously employed for each individual electron emitter.

FIG. 6 illustrates another configuration for an emitter cluster. As described above, emitter clusters may include any number of electron emitters dispersed in a symmetric or random (asymmetric) pattern. Typically, the electron emitters may be disposed, such that the electron emitters are closely positioned within the emitter cluster. Such an arrangement enables the electron beams, produced by the electron emitters, to be directed together to form a collective spot on the storage medium. For example, as shown in FIG. 6, emitter cluster 168 includes multiple electron emitters, including five electron emitters 170. Electron emitters 170 may be positioned asymmetrically within the emitter cluster. Focusing the electron emitters may include using one or more focusing electrodes. Such asymmetrical arrangements may reduce certain non-axially-symmetrical aberrations associated either with individual focusing electrodes or with focusing electrodes that are applied collectively to a group of electron emitters.

For example, each of the electron emitters may be effectively aligned to project an electron beam that produces a spot that is substantially superimposed upon the spots produced by the other electron emitters in the emitter cluster. In some embodiments, a single focusing electrode or cluster electrode 172 may be used to direct the electron beams emitted from the electron emitters onto the storage medium. Alternatively, in other embodiments, each electron emitter within an emitter cluster may have its own individual focusing electrode configured to focus the associated electron beam from the electron emitter onto a predetermined spot on the storage medium.

As described above, in operation, an emitter cluster generates a plurality of electron beams from the electron emitters within the emitter cluster. The electron beams are concentrated onto a storage medium to form a collective spot. The collective spot is aligned with a selectable data storage location such that the energy state of the data storage location may be determined and/or altered. As described above, the state of the data storage location may be detected by measuring the signal current or backscattered electrons resulting from bombardment of the data storage location with the plurality of electron beams from an emitter cluster. It should be appreciated that the electron beams may also be used to write on the storage medium, permanently or reversibly changing the energy state of the data storage location.

FIGS. 7 and 8 illustrate another configuration for an emitter cluster according to another embodiment of the present invention. Specifically, emitter cluster 174, depicted in FIGS. 7 and 8, includes a plurality of point emitters, including satellite emitters 176 and a central emitter 178. Electron emitters 176 and 178 are configured to generate electron beams 180 and 182, respectively.

Point emitters, also referred to as tip emitters, typically are cone shaped and have emitter tips or points from which narrow focused beams of electrons may be emitted. During operation, a pre-selected potential difference is applied between the point emitter and a corresponding extractor electrode 179. The extractor electrode may be a circular gate that surrounds the point emitter. Due to the sharp point of the point emitter, an electron beam current is extracted from the point emitter and directed with a high degree of precision towards the data storage location.

In the configuration illustrated in FIGS. 7 and 8, focusing electrodes are used to focus the electron beams to form a collective spot. For example, focusing electrodes, 186 and 188, are used to focus electron beams generated by electron emitters 176 and 178 onto storage medium 106 to form a collective spot 184. The first electrode 186 initially collimates the electron beams as they are generated from the electron emitters. The second electrode 188 directs the electron beams such that they are coincident to form a collective spot on the storage medium.

As described above, in operation, multiple electron beams are generated from multiple electron emitters in an emitter cluster. The electron beams generated from the emitter cluster may be focused such that the electron beams are coincident on the storage medium to form a collective spot on a is selected data storage location. The state of the data storage location may be determined, including reading the state of the data storage location or writing to the data storage location.

What is claimed is:

1. An emitter cluster for a data storage device comprising:
a plurality of electron sources, each electron source configured to emit an electron beam to form a collective spot on a storage medium.

2. The emitter cluster of claim 1, wherein each of the electron beams emitted from the plurality of electron sources are configured to converge toward each other.

3. The emitter cluster of claim 1, wherein the spots formed by the electron beams are substantially superimposed.

4. The emitter cluster of claim 1, wherein each of the electron beams converges at a single point on the storage medium.

5. The emitter cluster of claim 1, wherein at least one electron source is a point emitter.

6. The emitter cluster of claim 1, wherein at least one electron source is a flat emitter.

7. The emitter cluster of claim 1, wherein the plurality of electron sources includes at least one central electron emitter surrounded by a plurality of satellite electron emitters.

8. The emitter cluster of claim 1, wherein the electron sources are asymmetrically arranged.

9. A data storage device comprising:
a storage medium having at least one data storage location; and
a plurality of electron sources configured to generate a plurality of electron beams that coalesce to form a collective spot on the data storage location.

10. The data storage device of claim 9, wherein the electron beams are concentrated to form the collective spot.

11. The data storage device of claim 9, wherein the electron beams converge at a single point on the data storage location.

12. The data storage device of emitter cluster of claim 9 wherein the electron beams are substantially superimposed on the data storage location.

13. The data storage device of claim 9 wherein at least one electron source is a point emitter.

14. The data storage device of claim 9 wherein at least one electron source is a flat emitter.

15. The data storage device of claim 9 wherein the plurality of electron sources includes at least one central electron emitter surrounded by a plurality of satellite electron emitters.

16. The data storage device of claim 9 wherein the electron sources are asymmetrically arranged.

17. The data storage device of claim 9 further comprising at least one electrode configured to direct the electron beams onto the data storage location.

18. A data storage device comprising:
an emitter cluster having a plurality of electron emitters, wherein each electron emitter is configured to produce an electron beam;
at least one electrode configured to direct the electron beams from the emitter cluster; and
a storage medium with a data storage location configured to receive the electron beams from the emitter cluster, wherein the electron beams form a collective spot on the data storage location.

19. The data storage device of claim 18, wherein the electron emitters are asymmetrically arranged within the emitter cluster.

20. The data storage device of claim 18, wherein the emitter cluster includes at least one centered electron emitter and at least two satellite electron emitters.

21. The data storage device of claim 20, wherein the satellite electron emitters are symmetrically decentered.

22. The data storage device of claim 18, wherein each electron emitter has an individual electrode configured to direct the respective electron beam produced by the electron emitter onto the data storage location.

23. The data storage device of claim 18, wherein the emitter cluster is configured to write data onto the storage medium.

24. The storage device of claim 18, wherein the emitter cluster is configured to read data from the storage medium.

25. A data storage device including:
a first electron emitter configured to emit an electron beam;
a second electron emitter in close proximity to the first electron emitter and configured to emit an electron beam;
a storage medium having a data storage location, and
a beam positioner configured to direct the electron beam from the first electron emitter toward the electron beam from the second electron emitter to form a collective spot on the data storage location.

26. The data storage device of claim 25, wherein the beam positioning is configured to substantially superimpose the electron beam from the first electron emitter on the electron beam from the second electron emitter to form a collective spot on the data storage location.

27. The data storage device of claim 25, wherein the beam positioning is configured to concentrate the electron beams to form a collective spot on the data storage location.

28. The data storage device of claim 25, wherein the beam positioning includes an electrode configured to direct each of the electron beams.

29. The data storage device of claim 25, wherein the beam positioning includes a plurality of electrodes, where each electrode is configured to direct corresponding electron beam.

30. A method of forming a spot on a storage medium, the method comprising:
aligning an emitter cluster relative to a data storage location on the storage medium, where the emitter cluster is configured to produce a plurality of electron beams; and
concentrating the electron beams to form a collective spot on the data storage location.

31. The method of claim 30, wherein concentrating the electron beams includes substantially superimposing the electron beams.

32. The method of claim 30, wherein concentrating the electron beams includes directing the electron beams using at least one electrode.

33. The method of claim 30, wherein the data storage location is in one of a plurality of states, and the method further comprises detecting the state of the data storage location.

34. The method of claim 30, wherein the data storage location is in one of a plurality of states and the method further comprises changing the state of the data storage location.

35. The method of claim 30, wherein the emitter cluster includes a plurality of electron emitters.

36. The method of claim 30, wherein the emitter cluster includes at least one point emitter.

37. The method of claim 30, wherein the emitter cluster includes at least one flat emitter.

38. A method of reading or recording data on a storage medium, the method comprising:
generating an electron beam from a first electron emitter in an emitter cluster;
generating an electron beam from a second electron emitter proximally disposed the first electron emitter in the emitter cluster;
directing the electron beams such that they are coincident to form a collective spot on a data storage location on the storage medium; and
determining a state of the data storage location.

39. The method of claim 38, wherein determining the state of the data storage location includes writing onto the data storage location.

40. The method of claim 38, wherein determining the state of the data storage location includes reading the state of the data storage location.

41. A data storage device comprising:
a means for storing data;
a means for generating a first electron beam and a second electron beam;
a means for directing the first electron beam and the second electron beam to form a collective spot on the means for storing data.
